(19) United States
(12) Patent Application Publication
(10) Pub. No.: US 2010/0025504 A1
(43) Pub. Date: Feb. 4, 2010

(54) Drum seed spreader

(76) Inventors: Kevin J. Pierce, Grand Forks, ND (US); Michael J. Pierce, Grand Forks, ND (US); Randy Dufault, East Grand Forks, MN (US)

Correspondence Address: ROBERT E. KLEVE, 1103-24TH AVE S., GRAND FORKS, ND, 58201, US

(21) Appl. No.: 12/220,856

(22) Filed: Jul. 29, 2008

(51) Int. Cl. A01C 7/02; A01C 15/00

(52) U.S. Cl. 239/681; 239/147; 222/619; 222/167

(57) ABSTRACT

The invention comprises a seed spreader having a cylindrical drum mounted upon a pair of wheels for traviling the drum along the wheels for distributing seed along path upon the ground. The drum rotates with the wheels as the wheels rotate along the ground as an operator pushes the wheels forward by a handle mounted to the drum. The drum is hollow and has a door which can be opened to enable seed to be deposited into the interior of the drum. The drum has a plurality of holes about its exterior so that seed can travel out the the holes onto the ground as the drum is rotated as the wheels travel along the ground

It relates to spreaders, more particularly it relates to peat spreaders.

It is an object of the invention to provide a novel drum like granular spreader for containing and moving the drum along the ground with the drum having a plurality of holes about its circumference to of a shape and character to allow materials such as granular peat in a liquid in the drum to gravitate out the holes in the drum, as the drum is rolled along generally parallel to the ground.

Further objects and advantages of the invention will become apparent as the description proceeds and when taken in conjunction with the accompanying drawings wherein:

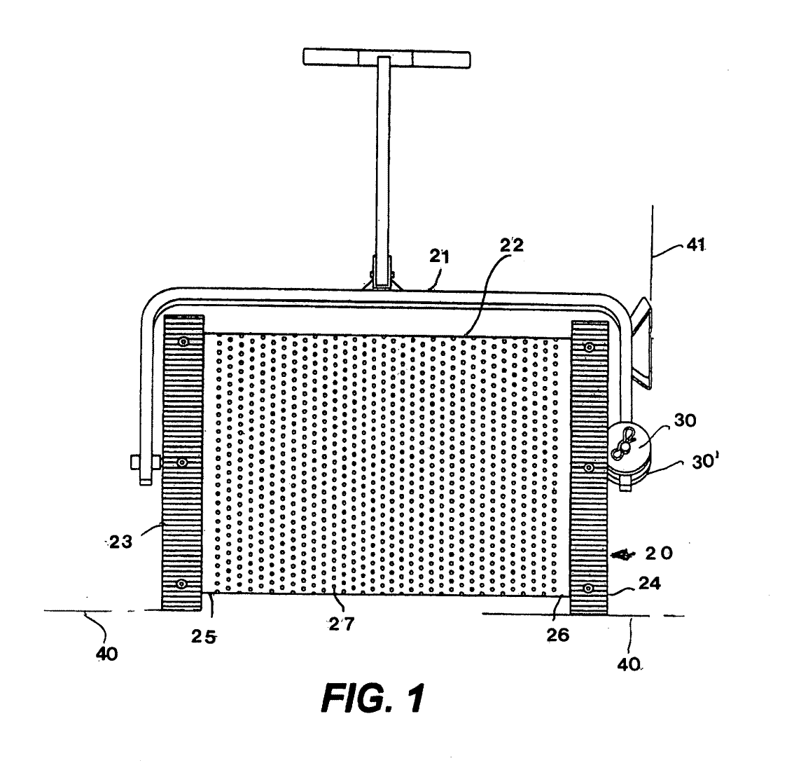

FIG. 1 is a front view of the peat spreader.

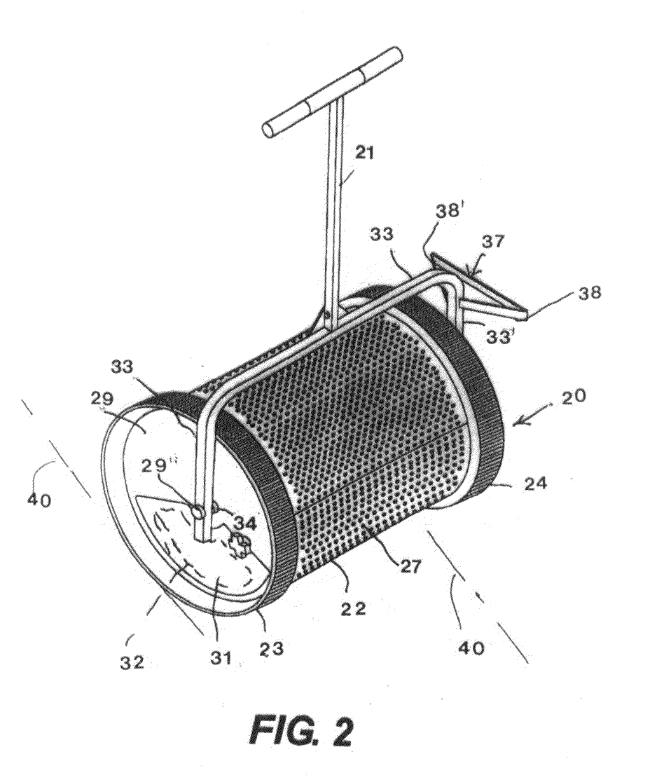

FIG. 2 is a left perspective view of the peat spreader

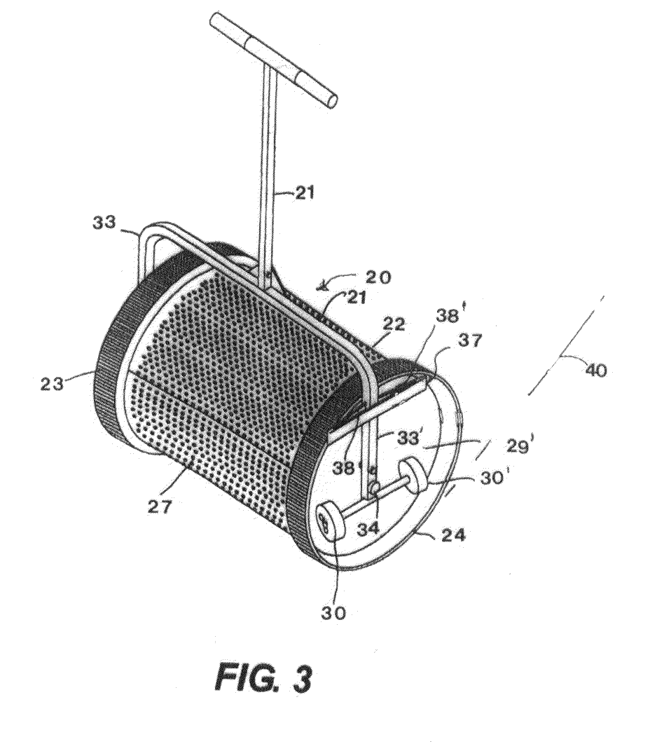

FIG. 3 is a right perspective view of the peat spreader

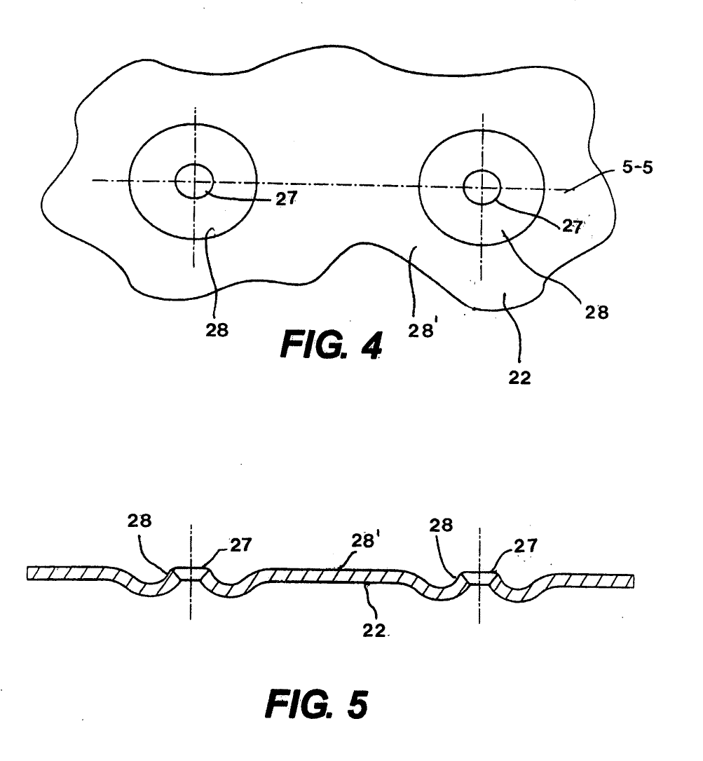

FIG. 4 is an enlarged fragmentary view of a portion of the interior of cylindrical drum illustrating one of the plurality of openings in the drum and the cylindrical inner ridge surrounding each opening forming a dimple like shape.

FIG. 5 is a cross sectional view of a portion of the drum of the peat spreader taken along line 5-5 illustrating the shape of the openings in the drum including the inner raised annular ridge about each opening.

Referring more particularly to the drawings, spreader 20 has a towable handle 21 and a drum 22 with a pair of wheels 23 and 24 rotatably mounted at the opposing ends 25 ad 26 of the cylindrical drum.

The spreader device 20 is adapted to received a mixture of powdered peat and water in the interior of the drum. The drum 22 is formed of a cylindrical sheet having a plurality of spaced openings or holes 27 extending into the drum with a raised ridge 28 on the inside 28′ of the drum adjacent each opening and formed into an annular ridges or inward projections 28 along the interior 28′ extending into the drum.

These ridges act to engage the peat inside the drum to cause it to be obstructed in path in the drum adjacent the openings or holes to prevent it from sliding past the openings so that it may more readily gravitate out through the openings out of the drum, rather than slide past the openings to thereby distribute the peat more evenly and thoroughly out through the openings onto the ground.

The wheels 23 and 24 for operating the device are fixed to the ends of the drum and act to space the drum above the ground and support the drum, as they rotate along the ground by being towed or pushed by the handle 21 as illustrated by phantom lines 39 as the peat is spread upon the ground by the drum by the peat gravitating out the drum through the openings 27. The wheels having a larger diameter then the drum act to prevent the drum from directly engaging the ground, which ground and materials on the ground otherwise has a tendency to clog the holes or openings and interrupt the spreading operation.

The wheels 23 and 24 have end discs, caps or covers 29 and 29′ mounted centrally in the wheels 23 and 24.

The drum 22 can be turned upright to rest on wheels 30 and 30′ on the ground as illustrated by phantom lines 40, so that the upper end cap 29 can be placed horizontally at the top of the drum 22 for refilling the drum with peat. The upper end cap 29 has a slidable cover 31 pivotally mounted at pivot point 29″ to slide across the opening 32 in the upper end cap 29 to open and close the opening. The cover has a knob which can be threaded into the end disc to lock the cover closed.

The handle has a pair of opposing branch arms 33 and 33′ which extend down on opposite ends of the drum to pivotally mount the arms to the drum. To mount the arms to the drum a center pin 34 extends through the center of the drum and through bores 35 and 35′.

For filling the drum with peat, the second pair of wheels 30 and 30′ are rotatably mounted on a rod 36 and the rod 36 is fixed to the end of the branch arm 33′ of the device. The second pair of wheels 30 and 30′ are rotatably mounted at opposite ends of the rod 36 of the branch arm, so that the drum can be upended onto the wheels 30 and 30′ onto the ground as illustrated by phantom lines 40 in FIG. 1. The drum, when upended, can be filled by opening the cover 31 by sliding and pivoting the cover away from the opening 32. The drum 22 can be supported by the wheels 30 and 30′ and may be rolled on the ground on the wheels while the drum is in its upright or upended position.

The second pair of wheels 30 and 30′ are spaced from one another and are mounted centrally on the end disc 29′; and a triangular ground support 37 is also mounted on one edge of the end disc or cover 29′, as illustrated in FIG. 3. The triangular ground support has diagonal portions 37′ and 37″ fixed to the end disc 29′ and a base support portion 38, which acts to engage with the ground with the drum is upright so that the wheels and ground support can support the drum when upended for filling.

Thus it will be seen that providing a novel manuable pushable device for spreading liquified peat onto the ground evenly with relative ease by simply towing the drum by the handle as it rolls on its drum wheels along the ground with the dimpled shape of the openings assisting in interrupting the peat as it is rolled along the interior of the drum which tends to cause the peat to bounce up and drop through the openings rather than simply pass by the openings if the openings do not have a dimpled area adjacent the opening.

It will be obvious that various changes and departures may be made to the invention without departing from the spirit and scope there of accordingly it is not intended that the invention be limited to the specifically described in the specification or as illustrated in the drawings but only as set forth in the appended claims wherein:

What is claimed is:

1. A peat spreader apparatus comprising a hollow cylindrical drum, a pair of wheels mounted at each end of the drum, said wheels having a diameter larger than the diameter of the drum so that when said drum is placed with its center axis is parallel to the drum said wheels will be placed on the ground to provide a rolling surface for supporting said drum spaced off the ground by said wheels, said drum having a plurality of holes in its circumference, so that peat liquified may be placed in the drum and as the drum is rotated by the rotation of the wheels rolling along the drum, the holes will allow the liquified peat to gravitate out the the holes onto the ground to provide spread of peat onto the ground in spaced intervals determined by the spacing of the holes in the drum.

2. A peat spreader according to claim 1, wherein said drum provides an annular projection about the holes projecting inward into the interior surfaces of the drum to provide dimple like projections into the drum to engage and fluff up the peat in the drum to cause it to readily gravitate out the the holes in the drum to provide a more readily emitting from the drum onto the ground.
A granular spreader comprising a hollow, cylindrical drum having a center axis, handle means adapted to be attached to the ends of the drum and adapted to place the drum with its center axis parallel to the ground, end caps at the ends of the drum, a wheel mounted to each end of the drum with said wheels having a diameter larger than the diameter of the drum so that as the drum is rolled along the drum on their wheels, the drum will be spaced by the wheels above the ground rolled along the drum on their wheels, the drum will be spaced by the wheels above the ground and generally parallel to the ground, said drum having a plurality holes into the interior of the drum, opening means into the drum to enable liquified granular material to the interior of the drum, said drum having ridge means adjacent the drum holes extending into the interior of the drum to interrupt the flow of the granular material as it passes the openings while rolled gravitationally in the drum due to the drum rotation and the interruption of the flow of material make easier for the granular material to gravitate down the holes out of the drum and onto the ground.

4. A granular spreader according to claim 3, where said opening means is at one of the end caps of the drum and a set of wheels are mounted are mounted to the opposing end cap so that the drum may be upended with the other end of the drum extending toward the ground and rolled on the set of wheels while up ended and the granular material may be loaded into drum interior through the opening in the one end cap for subsequent spreading of the granular material onto the ground.

5. A granular spreader comprising a hollow drum, wheel means for rolling the drum along the ground, said drum being adapted to carry granular material therein, perforations in the drum to enable the granular material to gravitate out of the drum through the perforations in the ground onto the ground for dispersing the granular material onto the ground.
